(19) United States
(12) Patent Application Publication
(10) Pub. No.: US 2012/0131582 A1
(43) Pub. Date: May 24, 2012

(54) System and Method for Real-Time Batch Account Processing

(75) Inventor: Xu Zhao, Hangzhou (CN)

(73) Assignee: ALIBABA GROUP HOLDING LIMITED, Grand Cayman (unknown)

(21) Appl. No.: 13/003,934

(22) PCT Filed: Jun. 24, 2010
(86) PCT No.: PCT/US10/39763

§ 371 Date: Jan. 13, 2011

(30) Foreign Application Priority Data
Jul. 22, 2009 (CN) 200910159659.0

(51) Int. Cl. G06F 9/46

(52) U.S. Cl. 718/101

(57) ABSTRACT

The present disclosure discloses a technique for real-time batch account processing. In one aspect, a method includes: (1) receiving, by an account processing center, a marked request for batch processing; (2) caching the marked request; (3) pre-processing sub-requests of a type relating to an account that are in the marked request, including merging operations of a type for processing for the account; and (4) processing the marked request, including the pre-processed sub-requests, to provide a processing result to a corresponding client. The request for batch processing can be directly submitted at the client or submitted by a client through an interface that is provided to the client for submitting a request including the request for batch processing. When submitting the request for batch processing, the client can wait for the processing result online, and obtain the processing result at real-time. Further, when receiving the request for batching processing, the account processing center can pre-process it, e.g., merging operations for the same account, and thus increase efficiency of batch processing.

### CROSS REFERENCE TO RELATED PATENT APPLICATIONS

This application is a national stage application of an international patent application PCT/US10/39763, filed Jun. 24, 2010, which claims priority from Chinese Patent Application No. 200910159659.0, filed Jul. 22, 2009, entitled “SYSTEM AND METHOD FOR REAL-TIME BATCH ACCOUNT PROCESSING,” which applications are hereby incorporated in their entirety by reference.

### TECHNICAL FIELD

The present disclosure relates to internet field, and particularly relates to a system and method for real-time batch account processing.

### BACKGROUND

FIG. 1 illustrates an existing account processing system. The account processing system includes an account processing center 11 and several clients 12. Account processing center 11 can reach client 12 through dedicated line or network (internet or intranet). There can be multiple clients 12. Client 12 can be a terminal or a network. Account processing center 11 includes at least a server 21 and a database 22. Database 22 is configured to store accounts information and various processing information. Server 21 is configured to conduct various operations and managements of accounts.

In an example where account processing center 11 is a third-party payment platform, when client 12 sends an instruction to account processing center 11 to pay fund in account A to several other accounts (such as accounts B1, B2, B3, . . . , Bn) of which payment amount is S1, S2, S3, . . . , Sn, respectively, the existing payment process is described below.

Firstly, account processing center 11 receives a request for payment operation from client 12.

Then payment account processing center 11 processes one payment operation.

Server 21 determines whether the balance in account A is higher than amount S1 by visiting account A in database 22. If the balance in account A is higher than S1, it locks account A and account B1, deducts amount S1 from account A and increases amount S1 in account B1 in the database, and releases locks of account A and account B1 after completion of the payment operation.

Thus, account processing center 11 needs n times of operations to complete the payments. Such processing operation has several technical pitfalls.

The existing payment process requires frequent operations of account A. Each operation requires locking account A and releasing account A after completion of the payment operation. This causes not only low processing efficiency of server 21 but also sharp reduction of processing capabilities of server 21 such that it cannot even receive processing request sent by other clients and, if serious, collapse of server 21 may occur.

Specifically, when there are relatively high amount of requests to batch process the accounts or there are many accounts to be processed in such batch processing, high operation burden is placed on server 21. This easily results in high traffic of processing requests at server 21 and rising failure rates of processing requests, thereby affecting client customers' experience.

To solve such problems, technicians of account processing center 11 attempted to carry out lots of researches and raised a method for asynchronous processing batch accounts by using an example of bank subsystem described below.

Account processing center 11 receives an instruction from a client to pay fund in account A to several other accounts (such as account B1, B2, B3, . . . , Bn) of which payment amount is S1, S2, S3, . . . , Sn respectively. Account processing center 11 pre-stores such instruction, waits until a proper time to process the instruction, saves a processing result of the instruction, and feedbacks the processing result to client 12 when proper. Generally, account processing center 11 will not process the instruction until a queue to request processing at server 21 is not long, such as late night. Such processing can reduce the problem of high operation pressure of server 21 due to batch processing. However, this approach has low real-time processing effects, especially when the balance in account A at client 12 is not sufficient to cover the amount while client 12 cannot timely know such information. As a result, the whole payment processing will be impacted.

### SUMMARY OF THE DISCLOSURE

The present disclosure provides a system for real-time batch account processing to solve the problems of existing technologies, such as high operation pressure at server and low real-time efficiency due to batch account processing.

To achieve the goal, the present disclosure provides the system for real-time batch account processing, which may include an account processing center and a client.

The client may include a batch processing unit configured to mark a request for batch processing, and a center interaction unit configured to establish an interaction with the account processing center.

The account processing center may further include: a batch processing identification unit configured to identify the request for batch processing from received requests; a pre-processing unit configured to pre-process a same type of request for processing relating to a same account in a batch processing, including merging all of the same type of request for processing of the same account; and a request processing unit configured to process the request for batch processing after operations including pre-processing, and to return a processing result to a corresponding client.

The pre-processing unit and the batch processing identification unit may be installed in a pre-processing server. The request processing unit may be installed in a request processing server. Alternatively, the pre-processing unit and the batch processing identification unit may be installed in a pre-processing module. The pre-processing module and the request processing unit may be two parallel processing units.

The present disclosure also provides another system for real-time batch account processing, and may include an account processing center. The account processing center may further include a pre-processing unit and a request processing unit.

The pre-processing unit may include: a client interaction sub-unit configured to provide interface to a client to submit a request including request for batch processing; a pre-processing sub-unit configured to pre-process a same type of request for processing relating to a same account in a batch processing, including merging all of the same type of request for processing of the same account; and a request processing unit configured to process the request for batch processing after operations including pre-processing, and to return a processing result to a corresponding client.

The present disclosure further provides a method for real-time batch account processing to realize real-time process request for batch processing submitted by a client. The method may include:
(1) receiving, by an account processing center, a marked request for batch processing;
(2) caching the marked request;
(3) pre-processing sub-requests of a type relating to an account that are in the marked request, including merging operations of a type for processing for the account; and
(4) processing the marked request, including the pre-processed sub-requests, to provide a processing result to a corresponding client.

When conducting step (3), the method may concurrently conduct the following steps:

Processing requests, and returning a processing result to a corresponding client; or

Processing another request for batch processing, and returning a processing result to a corresponding client.

Further, prior to step (1), the method may also include: providing an interface for inputting an instruction to request batch processing to a client; obtaining the client's input batch processing information; and forming a request for batch processing after mark.

Alternatively, prior to step (1), the method may also include: receiving, by the client, a request for batch processing from a client; adding a beginning mark at a beginning of the request for batch processing; and adding an ending mark at an ending of the request for batch processing.

The present disclosure has several advantages compared with the existing technologies, as described below.

Firstly, when conducting the request for batch processing, the client can wait for the processing result online and obtain the processing result at real-time.

Secondly, when receiving the request for batch processing, the account processing center can pre-process it, e.g., merging operations with the same account, and thus increase efficiency of batch processing.

Thirdly, the present disclosure does not require modification to the existing request processing unit, and only adds the additional batch processing unit (which can be the latest software or server) to ensure the stability of the existing system.

Lastly, the present disclosure provides two implementable embodiments. One is that the client directly submits the request for batch processing to the account processing center. The other is that the account processing center provides an interface to the client to submit a request including the request for batch processing. Both of the two embodiments have easy-to-use advantages.

### BRIEF DESCRIPTION OF THE DRAWINGS

FIG. 1 shows an existing account processing system.

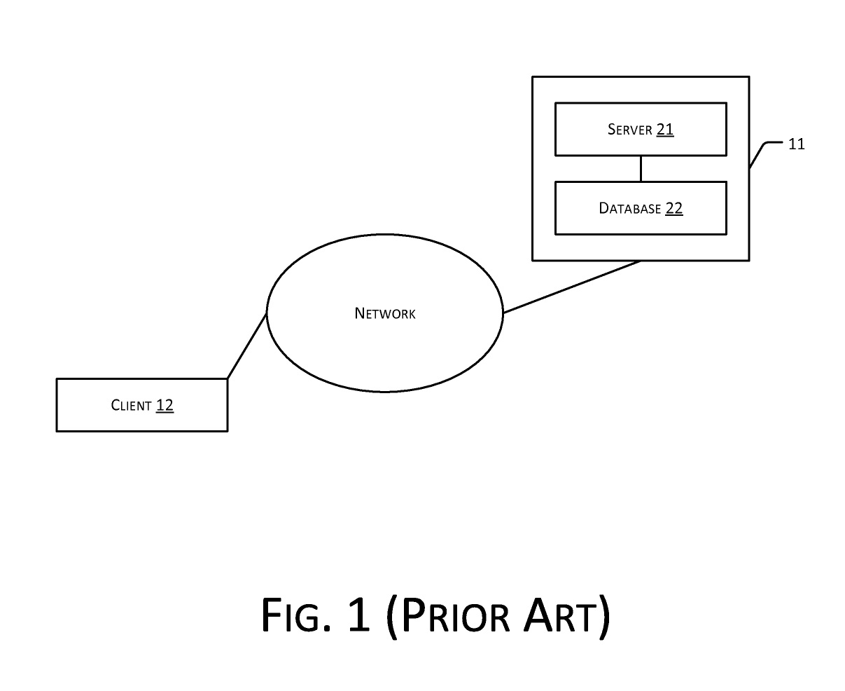

FIG. 2 shows an exemplary implementation of a system for real-time batch account processing in accordance with the present disclosure.

FIG. 3 shows a flowchart of a first method for real-time batch account processing in accordance with the present disclosure.

FIG. 4 shows a block diagram of an account processing center in accordance with the present disclosure.

FIG. 5 shows a flowchart of a second method for real-time batch account processing in accordance with the present disclosure.

### DETAILED DESCRIPTION

The follow detailed descriptions are illustrated by reference to the Figures.

### First Exemplary Embodiment

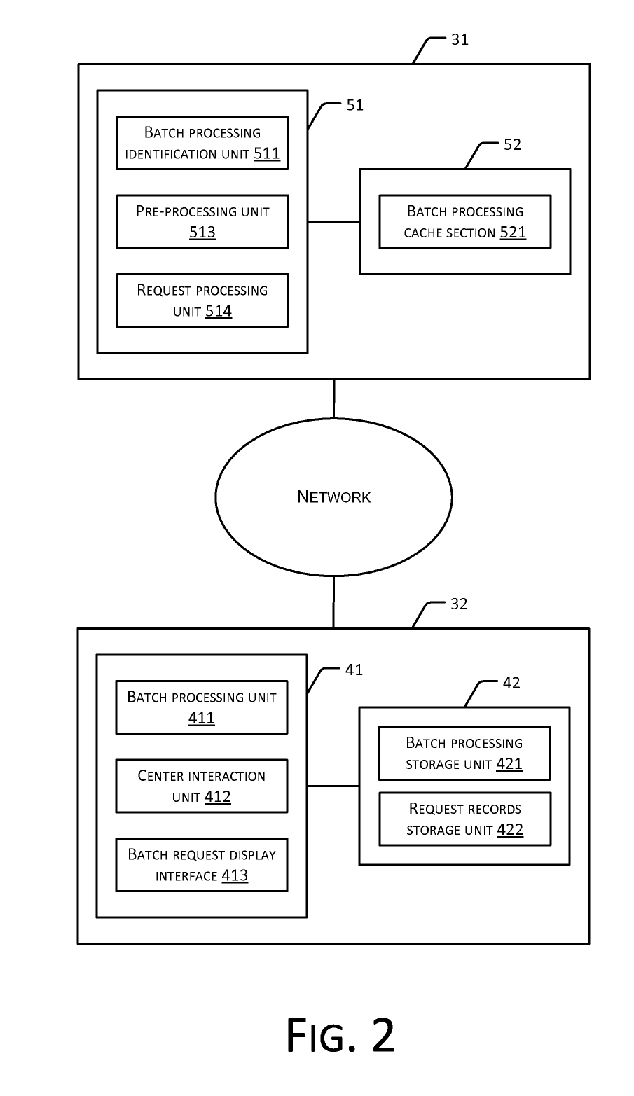

FIG. 2 illustrates an exemplary implementation of a system for real-time batch account processing in accordance with the present disclosure. The system includes an account processing center 31 and a client 32.

Client 32 can be a terminal, or a node at an intranet. Client 32 generally includes a memory 42 and a processor 41.

To implement real-time processing batch requests, account processing center 31 needs to provide to client 32 software or a hardware for request for batch processing. Generally, account processing center 31 provides software or a plug-in to client 32 via network, a compact disc (CD) including the software, or a universal serial bus (USB) including the software. Client 32 installs the software to implement a function to submit batch requests.

Client 32 includes processor 41 and memory 42. Processor 41 is configured to send a request including batch processing to the account processing center 31, and to receive a returning result from the account processing center 31. Memory 42 is configured to save information including the processing software, data for request, and the processing result. As the submission for request and saving of returning result are well known in the art, a detailed description will not be provided in the interest of brevity. The present disclosure only provides detailed descriptions of batch processing.

Processor 41 further includes a batch processing unit 411 and a center interaction unit 412.

The batch processing unit 411 is configured to mark a request for batch processing. When receiving a request for batch processing submitted by a client, the batch processing unit 411 marks the batch processing and submits the request.

The center interaction unit 412 is configured to establish an interaction with the account processing center 31. Client 32 generally has an interface for account processing center 31. Center interaction unit 412 sends the request to account processing center 31 through the interface, and receives the returned processing result through the interface.

Memory 42 further includes a batch processing storage unit 421 and a request records storage unit 422. Batch processing storage unit 421 is configured to store the batch processing software, especially to mark a beginning mark and an ending mark of the request for batch processing. Request records storage unit 422 is configured to store processing information for each request.

In addition, a batch request display interface 413 can be installed in the processor 41 of client 32. It connects batch processing unit 411 and is configured to provide batch processing instruction interface to the client. The batch request display interface 413 sends the client's request for batch processing to batch processing unit 411 which adds the beginning mark and the ending mark on the request for batch processing.

Account processing center 31 includes a server 51 and a database 52.

Server 51 further includes a batch processing identification unit 511, a pre-processing unit 513, and a request processing unit 514.

The batch processing identification unit 511 is configured to identify the request for batch processing from received requests.

The pre-processing unit 513 is configured to pre-process the same type of request for processing relating to the same account in a batch processing, including merging all of the same type of requests for processing of the same account.

The request processing unit 514 is configured to process the request for batch processing after operations including pre-processing, and to return the processing result to a corresponding client, such as the client 32.

Request processing unit 514 of server 51 is the same as an existing processing unit and no additional operation is required. Batch processing identification unit 511 and pre-processing unit 513 can be units separate from the existing request processing unit 514 in two forms: one is to set up a pre-processing server including batch processing identification unit 511 and pre-processing unit 513, and the other is to set up independent pre-processing modules in the current server 51. Batch processing identification unit 511 identifies the request for batch processing from received requests according to marks. Pre-processing unit 513 merges all requests to the same account as one request, and the format of the request complies with existing format requirements. Thus, when pre-processing unit 513 carries out operations, it does not interfere with operations of the existing request processing unit 514, hence two parallel processing units.

In addition to existing storage units (such as accounts storage unit and processing result storage unit), database 52 also includes a batch processing cache section 521 to connect with batch processing identification unit 511 and pre-processing unit 513, respectively. The batch processing cache section 521 is configured to cache the batch processing identified by batch processing identification unit 511. If an independent pre-processing server is installed, the pre-processing server includes batch processing identification unit 511 and pre-processing unit 513. In such situation, batch processing cache section 521 can be directly installed in the pre-processing server and directly stored in a memory of the server. On the other hand, if an independent pre-processing module is installed in server 51, batch processing cache section 521 can be installed in database 52 (as shown in the FIG. 2), or stored in a memory of server 51.

The above is only one exemplary embodiment. Such units can be logical units or physical units, e.g., units implemented by either software or hardware, and should not be construed as limiting the scope of the present disclosure.

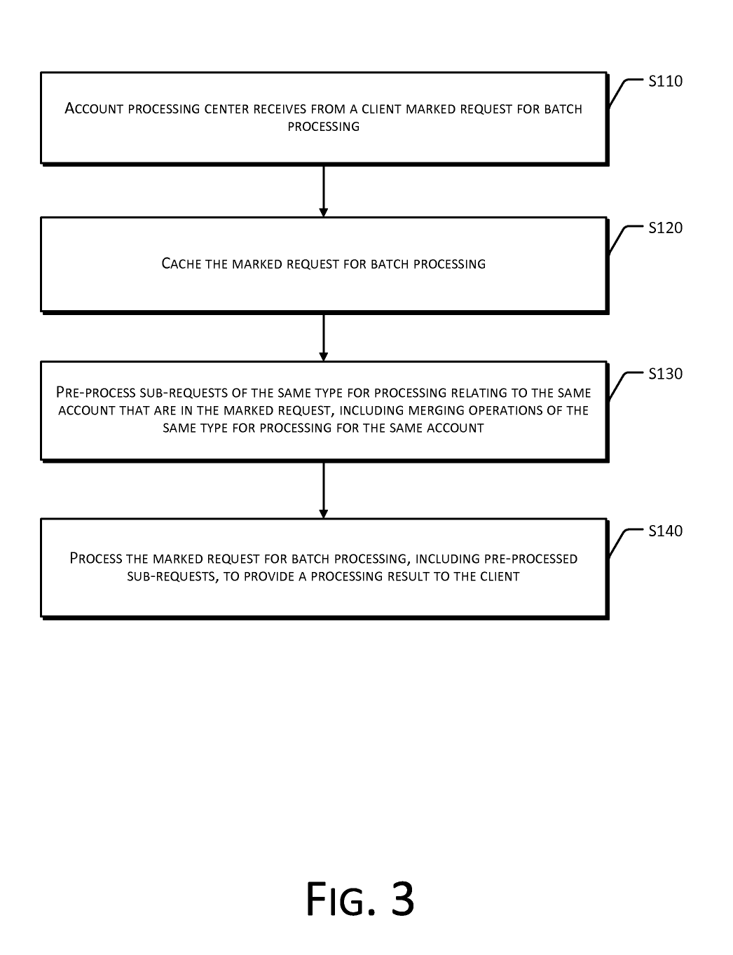

With regard to the above disclosed exemplary embodiment, FIG. 3 shows a flowchart of a first method for real-time batch account processing in accordance with the present disclosure. It is used to realize real-time processing requests for batch processing. The method includes several actions as described below.

S110: receiving, by an account processing center, from a client a marked request for batch processing.

The client at first conducts setups capable of batch processing, such as providing an interface to a client for receiving batch processing instructions.

When the client receives an instruction from the client to request batch processing, the client adds a beginning mark at a beginning of the request for batch processing and an ending mark at the end of the request for batch processing.

The client sends the marked request for batch processing to the account processing center.

The mark can be a common character mark. In one embodiment, the mark is mainly an instruction. When the account processing center receives the instruction, it can begin corresponding batch processing.

After the account processing center receives the request, pre-processing module/pre-processing server firstly determines whether the request is a request for batch processing. If affirmative, it starts operation of batch processing. Otherwise, it sends the request to a request processing unit for processing. The pre-processing module/pre-processing server determines whether the request is a request for batch processing according to the mark.

S120: caching the marked request for batch processing.

When the pre-processing module/pre-processing server determines that the request is a request for batch processing, it can cache the request for batch processing. For example, when it determines data included in the request is the beginning mark of the batch processing, it starts to cache data until it detects data that is the ending mark of the batch processing.

In one embodiment, such function is mainly completed by programming language. For example:

public class BatchTemplate {

| /** | |
|---|---|
| * | implement account's batch processing |
| * | |
| * | @return} |

When the client receives the request for batch processing input by the client, the client can add “public class BatchTemplate{” at the beginning and “@return” at the end. In fact, public class BatchTemplate is a template, i.e., the account processing center and the client can agree that “BatchTemplate” is a batch processing instruction, and the contained data is the data needing batch processing, and the account processing center and the client can agree on an order and content of such batch processing data. The client organizes data in the BatchTemplate template according to the agreement.

Such data, together with other data, are sent to the account processing center. After the account processing center receives the request, it finds “public class BatchTemplate” and understands it to be an instruction of request for batch processing, and starts to enforce the contained contents by using “@return” as the end of the instruction of request for batch processing.

S130: pre-processing sub-requests of the same type for processing relating to the same account that are in the marked request, including merging operations of the same type for processing for the same account.

Batch processing mainly refers to a plurality of operations of some accounts. Pre-processing mainly refers to unifying and categorizing all operations with respect to the same account. The merging of the same type of sub-requests for processing for the same account further includes: calculating all input/output, or transaction, amounts of the account and obtaining a final transaction amount.

After merging the same type of operations for the account, a new processing request is formed according to a format of request for processing.

S140: processing the marked request for batch processing, including the pre-processed sub-requests, to provide a processing result to the client.

When conducting step S130, the method concurrently conducts the following steps: processing requests, and returning a processing result to a corresponding client; or processing other requests for batch processing, and returning a processing result to a corresponding client.

In other words, when the request processing unit is conducting step 140, the pre-processing module/pre-processing server can pre-process other requests for batch processing.

In the above embodiment, a corresponding software or plug-in for batch processing is installed at the client. The client submits the request for batch processing through the installed software or plug-in at the client. In this embodiment, the client needs to install the corresponding software or plug-in.

### Second Exemplary Embodiment

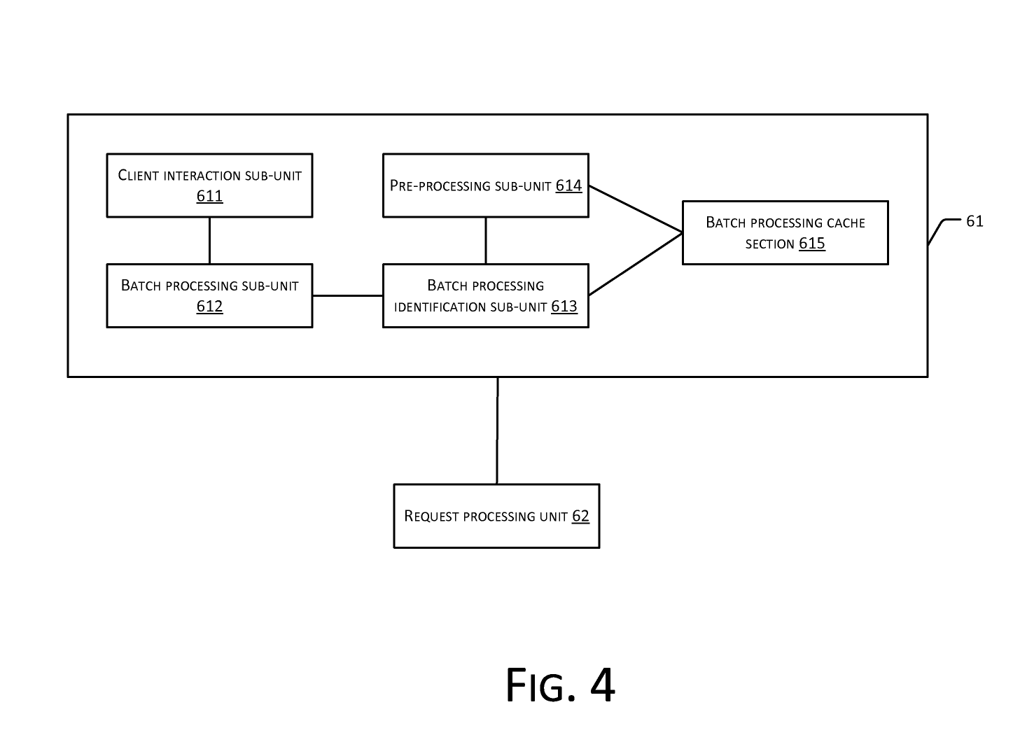

FIG. 4 shows a principle structural diagram of another embodiment of an account processing center in accordance with the present disclosure. The system includes a pre-processing unit 61 and a request processing unit 62. Request processing unit 62 can be an existing request processing unit. As an example, in a third-party payment platform, request processing unit 62 can be an existing payment processing system.

In this embodiment, a pre-processing unit 61 is added in the existing third-party payment platform. The pre-processing unit 61 includes a client interaction sub-unit 611, a batch processing sub-unit 612, a batch processing identification sub-unit 613, and a pre-processing sub-unit 614.

The client interaction sub-unit 611 is configured to provide an interface to a client for submitting a request including a request for batch processing. The client establishes an interaction with the pre-processing unit 61 through the client interaction sub-unit 611. The client can connect with client interaction sub-unit 611 through the Internet or wireless communication system. The interface for a client to submit the request for batch processing is installed in the client interaction sub-unit 611.

The pre-processing sub-unit 614 is configured to pre-process the same type of request for processing relating to the same account in a batch processing, including merging all of the same type of requests for processing for the same account.

When the client interaction sub-unit 611 receives only a request for batch processing, only the pre-processing sub-unit 614 is involved. Because client interaction sub-unit 611 receives other requests in addition to the request for batch processing submitted by the client, the pre-processing unit 61 also includes other components as described below.

The batch processing sub-unit 612 is configured to obtain the batch processing information input by the client, and to add marks to form the request for batch processing.

The batch processing identification sub-unit 613 is configured to identify the request for batch processing from the requests and to send the identified request for batch processing to pre-processing sub-unit 614.

When pre-processing unit 61 is implemented by an independent server, a space is established in a memory of the server, e.g., a batch processing cache section 615, configured to cache the request for batch processing identified by batch processing identification sub-unit 613. When pre-processing unit 61 is implemented by the server where the existing request processing unit 62 is located, a space is established in the existing database to cache the request for batch processing identified by batch processing identification sub-unit 613.

From the above, it can be understood that there needs no improvements on the client side in the second exemplary embodiment as long as the client can establish the interaction with client interaction sub-unit 611.

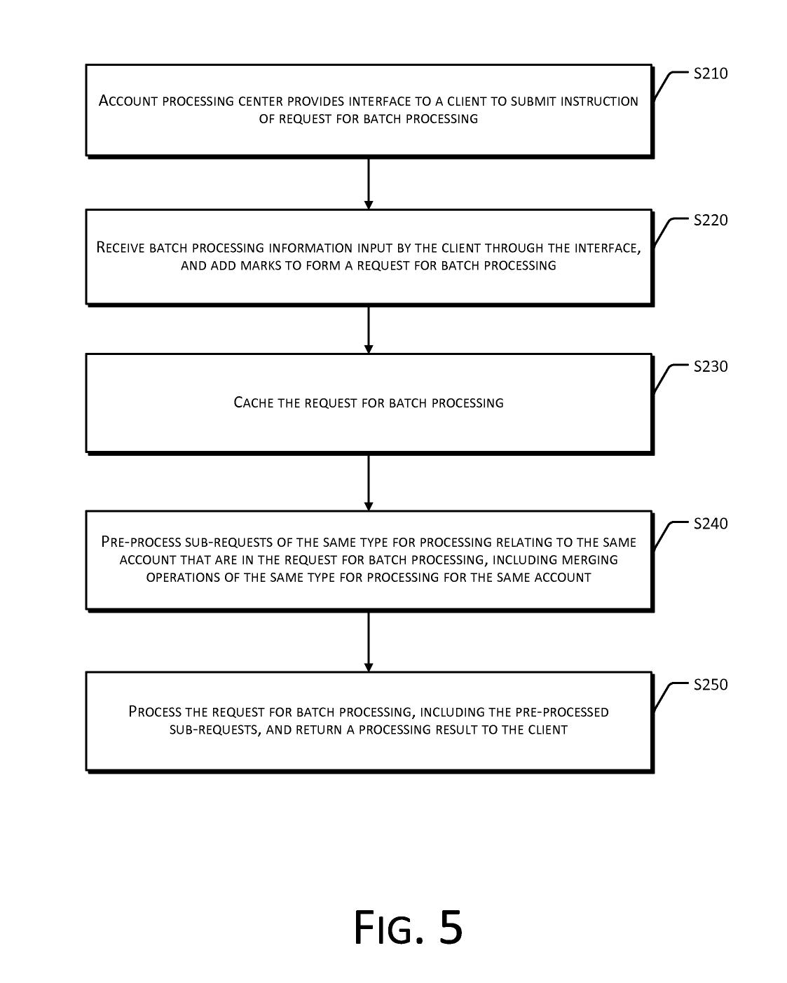

FIG. 5 shows a flowchart of a second embodiment for real-time batch account processing in accordance with the present disclosure. It is used for real-time processing of a request for batch processing submitted by the client, and includes several actions as described below.

S210: providing, by the account processing center, a interface to a client for submitting a request for batch processing.

A pre-processing unit provides the interface to the client, and receives a visit of a client to the interface through wireless communication network or the Internet.

S220: receiving batch processing information input by the client through the interface, and adding marks to form a request for batch processing.

The pre-processing unit receives the batch processing information input by the client, and adds a beginning mark and an ending mark to form a request for batch processing.

S230: caching the request for batch processing.

When the pre-processing unit determines that the request is a request for batch processing, it caches such request for batch processing. For example, when it determines data contained in the request indicating the beginning mark of the batch processing, it starts to cache them until detecting data that indicates the ending mark of the batch processing.

S240: pre-processing sub-requests of the same type relating to the same account that are in the request for batch processing, including merging operations of the same type for processing for the same account.

Batch processing mainly refers to a plurality of operations with respect to one or more accounts. Pre-processing mainly refers to unifying and categorizing all operations for the same account. The merging of the same type of operations for processing for the same account further includes: calculating all transaction amounts of the account and obtaining a final transaction amount.

After merging the same type of operations for the account, a new processing request is formed according to a format of request for processing.

S250: processing the request for batch processing, including the pre-processed sub-requests, and returning a processing result to the client.

### Application Scenario

The following is based on an example that the account processing center receives an instruction from the client to send fund in account A to 30 other accounts (account B1, B2, . . . , B30), in which payment for each account is $3,000.

The original payment process is as follows:

1. A→B1 (A pays $3,000 to account B1)
a) waiting to obtain a lock of account A
b) locking account A
c) waiting to obtain a lock of account B1
d) locking account B1
e) deducting $3,000 from account A
f) adding $3,000 to account B1

2. A→B2 (A pays $3,000 to account B2)
a) waiting to obtain a lock of account A
b) locking account A
c) waiting to obtain a lock of account B2
d) locking account B2
e) deducting $3,000 from account A
f) adding $3,000 to account B2

Thus account A needs to be locked 30 times. Such payment process is very slow. Further, when there is not sufficient fund in account A, such information can only be known at certain payment processing. Especially, when the client cannot timely know that there is insufficient fund for payment, it makes the payment process longer.

In an example of this application in accordance with the present disclosure:

1. Pre-processing
a) after analysis, planning A−$3,000*30
b) planning B1+$3,000
c) planning B2+$3,000
d) planning B30+$3,000

2. Processing
a) waiting to obtain a lock of account A
b) A−$90,000
c) waiting to obtain a lock of B1
d) B1+$3,000
e) waiting to obtain a lock of B2
f) B2+$3,000
g) waiting to obtain a lock of B30
h) B30+$3,000

Through such pre-processing, it can be timely determined whether or not there is sufficient fund in account A for a current payment, thereby increasing efficiency of the payment operation. In addition, the amount of time that A waits for the lock is greatly reduced by 29 times. In general, the time saved can be at a level of thousands or higher. Without the delay due to waiting, the system can accept much more other requests. This also increases the processing efficiency of the system overall.

### CONCLUSION

The disclosed method and system may be used in an environment or in a configuration of universal or specialized computer system(s). Examples include a personal computer (PC), a server computer, a handheld device or a portable device, a tablet device, a multi-processor system, a microprocessor-based system, a set-up box, a programmed customer electronic device, a network PC, a small-scale computer, a large-scale computer, and a distributed computing environment including any system or device above.

The present disclosure may be described within a general context of computer- executable instructions executed by a computer, such as a program module. Generally, a program module includes routines, programs, objects, modules, and data structure, etc., for executing specific tasks or implementing specific abstract data types. The disclosed method and server may also be implemented in a distributed computing environment. In the distributed computing environment, a task is executed by remote processing devices which are connected through a communication network. In distributed computing environment, the program module may be located in storage media (which include storage devices) of local and remote computers.

Above are only preferred exemplary embodiments of the present disclosure. However, the present disclosure is not limited hereto. It is appreciated that one of ordinary skills in the art can alter or modify the present disclosure in many different ways without departing from the spirit and the scope of this disclosure. These modifications and variations should therefore be considered to fall within the scope of the claims of the present disclosure and their equivalents.

After merging the same type of operations for the account, the technique forms a new processing request according to an original format of request for processing. In this application, after the same type of operation for account A is merged, a processing request is sent to the system, in which a format of the request for processing includes the following: account, operation amount, e.g., account A, expense amount $40,000.

The above are simply several detailed implementations of the present disclosure. However, such implementations cannot be used to limit the present disclosure. Any foreseeable modifications of a person of ordinary skill in the art are within the protection scope of the present disclosure.

What is claimed is:

1. A system for real-time batch account processing, comprising:
an account processing center comprising:
a batch processing identification unit that identifies a request for batch processing from received requests;
a pre-processing unit that pre-processes a type of requests for processing relating to an account in a batch processing, and merges all requests of the type for the account for processing; and
a request processing unit that processes the request for batch processing after the pre-processing, and provides a processing result; and
a client comprising:
a batch processing unit that marks the request for batch processing; and
a center interaction unit that establishes an interaction with the account processing center.

2. The system as recited in claim 1, wherein the pre-processing unit and the batch processing identification unit are installed in a pre-processing server, and wherein the request processing unit is installed in a request processing server.

3. The system as recited in claim 1, wherein the pre-processing unit and the batch processing identification unit are installed in a pre-processing module, and wherein the pre-processing module and the request processing unit are two parallel processing units.

4. The system as recited in claim 1, wherein the account processing center further comprises a batch processing cache section that connects with the batch processing identification unit and the pre-processing unit.

5. The system as recited in claim 1, wherein the client further comprises a batch processing mark storage unit that stores a beginning mark and an ending mark of the request for batch processing.

6. The system as recited in claim 5, wherein the client further comprises a batch request display interface that connects with the batch processing unit provides batch processing instruction interface to a client, and sends the client's request for batch processing to the batch processing unit to add the beginning mark and the ending mark on the request for batch processing.

7. A system for real-time batch account processing, comprising:
an account processing center comprising a pre-processing unit and a request processing unit, the pre-processing unit comprising:
a client interaction sub-unit that provides an interface to a client to submit a request including a request for batch processing;
a pre-processing sub-unit that pre-processes a type of request for processing relating to an account in a batch processing, and merges all requests of the type for processing for the account; and
a request processing unit that processes the request for batch processing after the pre-processing, and provides a processing result.

8. The system as recited in claim 7, wherein a communication between the account processing center and the client is through a network.

9. The system as recited in claim 7, wherein the pre-processing unit further comprises:
a batch processing sub-unit that obtains batch processing information input by the client, and adds marks to form the request for batch processing; and
a batch processing identification sub-unit that identifies the request for batch processing from a plurality of requests.

10. A method for real-time batch account processing to realize a real-time process request for batch processing submitted by a client, the method comprising:
receiving, by an account processing center, a marked request for batch processing;
caching the marked request;
pre-processing sub-requests of a type relating to an account that are in the marked request, including merging operations of a type for processing for the account; and
processing the marked request, including the pre-processed sub-requests, to provide a processing result to the client.

11. The method as recited in claim 10, further comprising:
prior to receiving the marked request for batch processing, providing an interface to a user for inputting an instruction to request batch processing;
obtaining batch processing information from the user; and
forming a request for batch processing.

12. The method as recited in claim 10, further comprising:
prior to receiving the marked request for batch processing, receiving, by the client, a request for batch processing from a user;
adding, by the client, a beginning mark at a beginning of the request for batch processing; and
adding, by the client, an ending mark at an ending of the request for batch processing.

13. The method as recited in claim 10, wherein the marked request for batch processing is identified by identifying a beginning mark and an ending mark from the plurality of requests.

14. The method as recited in claim 10, further comprising:
when conducting the pre-processing, concurrently:
processing requests and returning a processing result to a corresponding client; or
processing another request for batch processing and returning a processing result to the corresponding client.

15. The method as recited in claim 10, wherein the merging operations of the type for processing for the account further comprises:
calculating all transaction amounts of the account; and
obtaining a final transaction amount.

16. The method as recited in claim 10, wherein the pre-processing further comprises:
after merging operations of the type for processing for the account, forming a new processing request according to a format of request for processing.
